(19) United States
(12) Patent Application Publication
(10) Pub. No.: US 2025/0239102 A1
(43) Pub. Date: Jul. 24, 2025

(54) SUBJECT IDENTIFICATION BASED ON CHANGE AGNOSTIC FAMILY MATCHING

(71) Applicant: KINSAME TECHNOLOGIES LTD., MAGSHIMIM (IL)

(72) Inventors: Tomer SAAR, Hod Hasharon (IL); Aviram BAR-HAIM, Hod Hasharon (IL); Ayal BRENNER, Hod Hasharon (IL); Yoni DONNER, Rohnert Park, CA (US)

(73) Assignee: KINSAME TECHNOLOGIES LTD., MAGSHIMIM (IL)

(21) Appl. No.: 19/010,836

(22) Filed: Jan. 6, 2025

Related U.S. Application Data
(60) Provisional application No. 63/622,413, filed on Jan. 18, 2024.

(51) Int. Cl. G06V 40/16

(52) U.S. Cl. CPC G06V 40/172; G06V 40/168

(57) ABSTRACT

The present disclosure relates generally to identifying subjects based on correlated family relation (e.g., kinship) characteristics. Using the present techniques, a facial photo of a subject, suspected to be a grown-up missing child, or any other person who may or may not have undergone changes in their appearance, is presented. Regular facial recognition systems cannot find the subject because the photo is not in any database (and because only family member photos may be in the database, and/or the photo may be a past photo of the subject in which the subject looks significantly different). With change-agnostic family matching, the facial photo of the subject is matched with the closest family signature(s), such that a relevant family or families may be identified. Possible family matches are presented in descending order where the closest families are presented first.

### 1. CROSS-REFERENCE TO RELATED APPLICATIONS

This application claims priority to Provisional Patent Application Ser. No. 63/622,413, filed on Jan. 18, 2024, entitled: “SUBJECT IDENTIFICATION BASED ON CHANGE AGNOSTIC FAMILY MATCHING”, the disclosure of which is incorporated herein in its entirety.

### BACKGROUND

### 2. Field

The present disclosure relates generally to identifying a subject based on the subject's or his kin's (relative's) characteristics/phenotypes.

### 3. Description of the Related Art

The issue of missing children in the U.S. is a grave concern, with around 360,000 cases reported yearly. One significant challenge in these cases is the difficulty in identifying children who have grown up, as they often no longer resemble their childhood photos that relatives may still possess. This complicates efforts by families and law enforcement to locate them, despite the availability of such photos, emphasizing the need for advanced methods and continuous efforts in identifying a potentially missing child. Other techniques such as DNA tests require significant cost and effort compared to visual methods. State of the art systems are not currently able to identify such children, or others who may have undergone changes in their appearance.

### SUMMARY

The following is a non-exhaustive listing of some aspects of the present techniques. These and other aspects are described in the following disclosure.

Some aspects include system(s), method(s), and/or software for identifying subjects based on correlated family relation (e.g., kinship) characteristics. Advantageously, using the present techniques, a facial photo of a subject, suspected to be a grown-up missing child, or any other person who may or may not have undergone changes in their appearance, is presented. Regular facial recognition systems cannot find the subject because the photo is not in any database (and because only family member photos may be in the database, and/or the photo may be a past photo of the subject in which the subject looks significantly different). With change-agnostic family matching, the facial photo of the subject is matched with a closest family signature, and a relevant family is identified. Possible family matches are presented in descending order where the closest families are presented first.

In some embodiments, the system(s), method(s), and/or software described herein facilitate recognition of a subject by identifying the subject's family in an image gallery of families, whether or not the subject's appearance has changed, by exploiting a genetic similarity of facial features between family members. A family set is generated for a plurality of individuals. The family set comprises mapped family relations designated between the plurality of individuals in the family set. The image gallery of families is generated. The image gallery of families comprises one or more facial images of each of the plurality of individuals in the family set. The one or more facial images each comprise a unique identification that correlates to the mapped family relations designated between the plurality of individuals in the family set. The image gallery of families is processed based on the unique identifications to divide the plurality of individuals into different types of groups which represent common phenotypes in one or more facial images of group members. Weights are assigned and used to optimize familial signatures that represent different families in the image gallery of families.

One or more facial images of the subject is received. The one or more facial images of the subject comprise one or more current facial images taken after occurrence of potential appearance related changes to subject. One or more phenotypes of the subject is based on the one or more facial images of the subject. The one or more phenotypes of the subject are compared to the familial signatures to generate an ordered list of family probabilities from a family that most resembles the subject to a family that least resembles the subject. The system shows the highest-ranking families based on the comparison. The system is configured such that an operator can choose several families to check and come to final conclusions based on other clues from other sources of information, for example.

In some embodiments, the subject is or was a missing child, a baby or child who has aged to an older child or adult, a subject who has experienced significant weight gain or loss, a subject who has aged enough to significantly change in physical appearance, a subject who has experienced significant hair loss, and/or a subject who has changed in appearance in some other way.

In some embodiments, the plurality of individuals comprises hundreds of individuals, thousands of individuals, millions of individuals, or billions of individuals.

In some embodiments, the mapped family relations comprise parent-child, sibling-sibling, grandparent-grandchild, uncle/aunt-nephew/niece, and/or corresponding inverses of these relationships.

In some embodiments, a phenotype comprises a detectable characteristic in a facial image. Different phenotypes may comprise parts of faces, indications of kinship, age, gender, race, eye color, hair color, skin color, presence of unique skin characteristics, bone structure, and/or other detectable characteristics.

In some embodiments, assigning and using weights to optimize familial signatures that represent different families in the image gallery of families comprises: assigning weights based on different types of family relations, including parent-child, sibling-sibling, grandparent-grandchild, uncle/aunt-nephew/niece, cousin-cousin, and/or corresponding inverses of these; determining separate face embeddings for each of the plurality of individuals; and determining weighted averages of facial embeddings for different sub-groups, the different sub-groups comprising grandparents, uncles, aunts, cousins, parents, siblings, brothers, and/or sisters.

In some embodiments, assigning and using weights to optimize familial signatures that represent different families in the image gallery of families further comprises individually adjusting each weight as needed to enhance an accuracy of the familial signatures to represent the different families.

In some embodiments, familial embeddings, individual embeddings, and corresponding metadata are saved in a database.

In some embodiments, recognizing the subject is agnostic of whatever potential appearance related change may or may not have been undergone by the subject.

In some embodiments, the familial signatures are determined by extracting and aggregating common phenotypes associated with one or more facial images of individuals in a family. The aggregating may comprise averaging, as one example.

In some embodiments possible families in the ordered list may be displayed by a user interface, presented in descending order from the family that most resembles the subject to the family that least resembles the subject.

In some embodiments, comparing the one or more phenotypes of the subject to the familial signatures comprises determining an embedding representing the subject's face, with the embedding collectively representing one or more phenotypes associated with the subject, and comparing the embedding to each of the familial signatures. The ordered list of family probabilities is determined based on the comparing of the embedding to the familial signatures. In some embodiments, the embedding is multidimensional, with different dimensions corresponding to different phenotypes of the subject.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a logical-architecture block diagram that illustrates a system including an identification engine and other components as described herein configured for identifying subjects based on family relation (e.g., kinship) characteristics.

FIG. 2 is a schematic illustration of images of individuals from an image gallery of families.

FIG. 3 illustrates an image of an individual from an image gallery of families (e.g., an image of an individual from the image gallery of families shown in FIG. 2).

FIG. 4 is a diagram that illustrates an exemplary computing system in accordance with embodiments of the present system.

FIG. 5 is a flow chart that illustrates a process for identifying subjects based on correlated family relation (e.g., kinship) characteristics.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of unknown subject identification. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

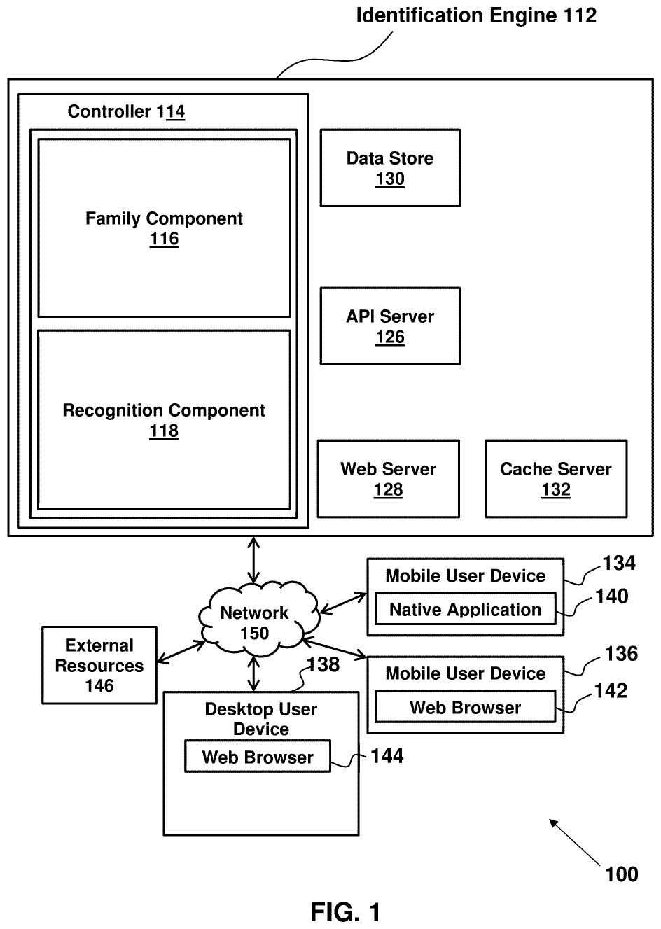

FIG. 1 illustrates a system 100 comprising an identification engine 112 and other components configured to identify subjects based on correlated family relation (e.g., kinship) characteristics. System 100 is configured to facilitate recognition of a subject by identifying the subject's family in an image gallery of families, whether or not the subject's appearance has changed, by exploiting a genetic similarity of facial features between family members.

As described above, typical systems have difficulty identifying subjects who have changed in appearance (e.g., a child who as aged or grown up, a person who has had a significant weight change or lost hair, etc.), as they often no longer resemble earlier photos of themselves. To overcome this and/or other difficulties, system 100 is configured to generate a set of families with mapped relations, i.e. father-son, father-daughter, brother-sister, grandmother-grandson, uncle-nephew, etc. System 100 obtains, assembles, receives, and/or otherwise generates an image gallery of families, with at least one photo per person, where photo identifications are unique and correlate to the relationships data provided. A pre-processing operation runs on family members, splits them into different types of groups representing common phenotype representations in the facial photos of the group members. Weights for different family relationships (kinship), face parts, age, gender, race, or any other phenotype can be used to optimize the familial signature for a good representation of the family. Familial embeddings, individual embeddings, and/or other metadata such as described herein is saved in a database.

The photo of a subject, suspected to have a changed appearance, is presented to system 100. Regular facial recognition systems cannot find the subject in the gallery because only family member photos are there, and the subject's photo may be of a person who has changed in appearance or may be absent from the database completely. With change-agnostic family matching, the photo of the subject is correlated by system 100 to a gallery family signature, such that one or more relevant possible matching families are identified. A score may be calculated for each possible match, for example. The possible families are presented in descending order where the highest ranking families are presented first.

These and other benefits are described in greater detail below, after introducing the components of system 100 and describing their operation. It should be noted, however, that not all embodiments necessarily provide all of the benefits outlined herein, and some embodiments may provide all or a subset of these benefits or different benefits, as various engineering and cost tradeoffs are envisioned, which is not to imply that other descriptions are limiting.

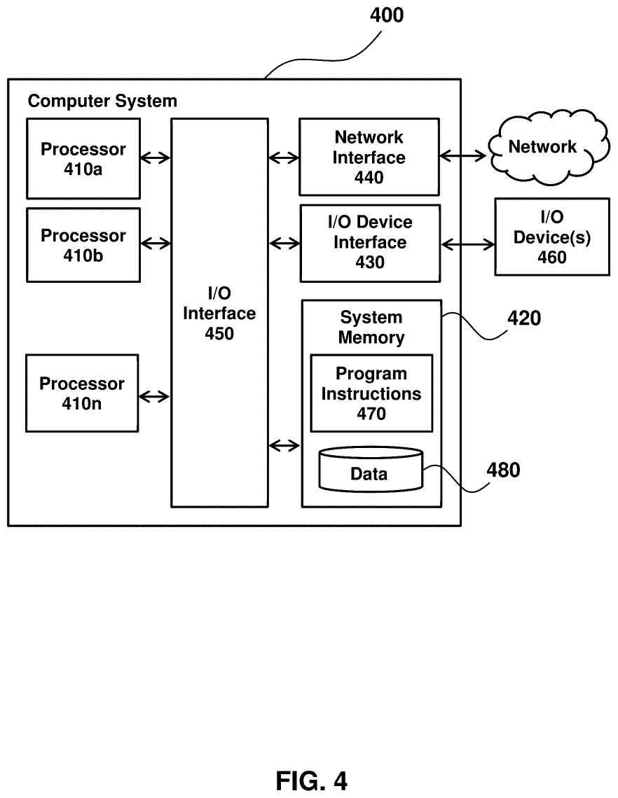

In some embodiments, identification engine 112 is executed by one or more of the computers described below with reference to FIG. 4 and may include one or more of a controller 114, an application program interface (API) server 126, a web server 128, a data store 130, and a cache server 132. These components, in some embodiments, communicate with one another in order to provide the functionality of identification engine 112 described herein. As described in greater detail below, in some embodiments, data store 130 may store and/or access data comprising one or more image galleries of individuals and/or other data.

Cache server 132 may expedite access to this data by storing likely relevant data in relatively high-speed memory, for example, in random-access memory or a solid-state drive. Web server 128 may serve webpages having graphical user interfaces that display one or more views that facilitate searching an image of a subject using the image gallery, recognizing the subject and/or the subject's family, displaying some and/or all of this or related information, and/or other views. API server 126 may serve data to various applications that process data related to user requested subject identifications, or other data. The operation of these components 126, 128, and 130 may be coordinated by controller 114, which may bidirectionally communicate with each of these components or direct the components to communicate with one another. Communication may occur by transmitting data between separate computing devices (e.g., via transmission control protocol/internet protocol (TCP/IP) communication over a network), by transmitting data between separate applications or processes on one computing device; or by passing values to and from functions, modules, or objects within an application or process, e.g., by reference or by value.

In some embodiments, interaction with users and/or other entities may occur via a website or a native application viewed on a desktop computer, tablet, or a laptop of the user. In some embodiments, such interaction occurs via a mobile website viewed on a smart phone, tablet, or other mobile user device, or via a special-purpose native application executing on a smart phone, tablet, or other mobile user device. Data (e.g., a gallery of images of individuals, etc.) may be extracted by controller 114 and/or other components of system 100 from data store 130 and/or other sources inside or outside system 100 in a secure and encrypted fashion. Data extraction by controller 114 may be configured to be sufficient for system 100 to function as described herein, without compromising privacy and/or other requirements associated with a data source. Facilitating secure subject identity determinations across a variety of devices is expected to make it easier for the users to complete identifications when and where convenient for the user, and/or have other advantageous effects.

To illustrate an example of the environment in which identification engine 112 operates, the illustrated embodiment of FIG. 1 includes a number of components with which identification engine 112 communicates: mobile user devices 134 and 136; a desk-top user device 138; and external resources 146. Each of these devices communicates with identification engine 112 via a network 150, such as the Internet or the Internet in combination with various other networks, like local area networks, cellular networks, Wi-Fi networks, or personal area networks.

Mobile user devices 134 and 136 may be smart phones, tablets, gaming devices, or other hand-held networked computing devices having a display, a user input device (e.g., buttons, keys, voice recognition, or a single or multi-touch touchscreen), memory (such as a tangible, machine-readable, non-transitory memory), a network interface, a portable energy source (e.g., a battery), and a processor (a term which, as used herein, includes one or more processors) coupled to each of these components. The memory of mobile user devices 134 and 136 may store instructions that when executed by the associated processor provide an operating system and various applications, including a web browser 142 or a native mobile application 140. The desktop user device 138 may also include a web browser 144. In addition, desktop user device 138 may include a monitor; a keyboard; a mouse; memory; a processor; and a tangible, non-transitory, machine-readable memory storing instructions that when executed by the processor provide an operating system and the web browser and/or the native application 140.

Native application 140 and web browsers 142 and 144, in some embodiments, are operative to provide a graphical user interface associated with a user, for example, that communicates with identification engine 112 and facilitates user interaction with data from identification engine 112. In some embodiments, identification engine 112 may be stored on and/or otherwise be executed user computing resources (e.g., a user computer, server, etc., such as mobile user devices 134 and 136, and desktop user device 138 associated with a user), servers external to the user, and/or in other locations. In some embodiments, identification engine 112 may be run as an application (e.g., an app such as native application 140) on a user server, a user computer, and/or other devices.

Web browsers 142 and 144 may be configured to receive a website from identification engine 112 having data related to instructions (for example, instructions expressed in JavaScript™) that when executed by the browser (which is executed by the processor) cause mobile user device 136 and/or desktop user device 138 to communicate with identification engine 112 and facilitate user interaction with data from identification engine 112. Native application 140 and web browsers 142 and 144, upon rendering a webpage and/or a graphical user interface from identification engine 112, may generally be referred to as client applications of identification engine 112, which in some embodiments may be referred to as a server. Embodiments, however, are not limited to client/server architectures, and identification engine 112, as illustrated, may include a variety of components other than those functioning primarily as a server. Three user devices are shown, but embodiments are expected to interface with substantially more, with more than 100 concurrent sessions and serving more than 1 million users distributed over a relatively large geographic area, such as a state, the entire United States, and/or multiple countries across the world.

External resources 146, in some embodiments, include sources of information such as databases (e.g., which may store one or more image galleries of individuals, etc.), websites, etc.; external entities participating with system 100 (e.g., systems or networks associated with security organizations, etc.), one or more servers outside of system 100, a network (e.g., the internet), electronic storage, equipment related to Wi-Fi™ technology, equipment related to Bluetooth® technology, data entry devices, or other resources. In some implementations, some or all of the functionality attributed herein to external resources 146 may be provided by resources included in system 100. External resources 146 may be configured to communicate with identification engine 112, mobile user devices 134 and 136, desktop user device 138, and/or other components of system 100 via wired and/or wireless connections, via a network (e.g., a local area network and/or the internet), via cellular technology, via Wi-Fi technology, and/or via other resources.

Thus, identification engine 112, in some embodiments, operates in the illustrated environment by communicating with a number of different devices and transmitting instructions to various devices to communicate with one another. The number of illustrated external resources 146, desktop user devices 138, and mobile user devices 136 and 134 is selected for explanatory purposes only, and embodiments are not limited to the specific number of any such devices illustrated by FIG. 1, which is not to imply that other descriptions are limiting.

Identification engine 112 may include a number of components that facilitate searching an image of a subject, recognizing the subject and/or the subject's family even if the image of the subject is not in any image galleries themselves, and even if the subject has changed in appearance. This is performed by exploiting a similarity of phenotype characteristics of the face of the subject to those of family members. For example, the illustrated API server 126 may be configured to communicate images, image galleries, and/or other information via a protocol, such as a representational-state-transfer (REST)-based API protocol over hypertext transfer protocol (HTTP) or other protocols. Examples of operations that may be facilitated by the API server 126 include requests to access or retrieve portions or all of one or more image galleries of families, and/or other information. API requests may identify which data is to be displayed (e.g., images, an indication of a determined family recognition, an indication of a subject identification, a confidence level associated with an identification, etc.), linked, modified, added, or retrieved by specifying criteria for identifying records, such as queries for retrieving or processing information about a particular subject (e.g., an image of a subject), for example. In some embodiments, the API server 126 communicates with the native application 140 of the mobile user device 134 or other components of system 100.

The illustrated web server 128 may be configured to display, link, modify, add, or retrieve portions or all of images, potentially matching families, an indication of an estimated family recognition, an indication of a subject identification, a confidence level associated with an identification, and/or other information encoded in a webpage (e.g. a collection of resources to be rendered by the browser and associated plug-ins, including execution of scripts, such as JavaScript™, invoked by the webpage). In some embodiments, the graphical user interface presented by the webpage may include inputs by which the user may enter or select data, such as clickable or touchable display regions or display regions for text input. For example, an image of a subject may be uploaded. Such inputs may prompt the browser to request additional data from the web server 128 or transmit data to the web server 128, and the web server 128 may respond to such requests by obtaining the requested data and returning it to the user device or acting upon the transmitted data (e.g., storing posted data or executing posted commands). In some embodiments, the requests are for a new webpage or for data upon which client-side scripts will base changes in the webpage, such as XMLHttpRequest requests for data in a serialized format, e.g. JavaScript™ object notation (JSON) or extensible markup language (XML). The web server 128 may communicate with web browsers, such as the web browser 142 or 144 executed by user devices 136 or 138. In some embodiments, the webpage is modified by the web server 128 based on the type of user device, e.g., with a mobile webpage having fewer and smaller images and a narrower width being presented to the mobile user device 136, and a larger, more content rich webpage being presented to the desk-top user device 38. An identifier of the type of user device, either mobile or non-mobile, for example, may be encoded in the request for the webpage by the web browser (e.g., as a user agent type in an HTTP header associated with a GET request), and the web server 128 may select the appropriate interface based on this embedded identifier, thereby providing an interface appropriately configured for the specific user device in use.

The illustrated data store 130, in some embodiments, stores and/or is configured to access images of individuals, image galleries of family's (e.g., if a certain database already facilitates grouping data by various categories including known relatives), and/or other information. Data store 130 may include various types of data stores, including relational or non-relational databases, image collections, document collections, and/or memory images, for example. Such components may be formed in a single database, or may be stored in separate data structures. In some embodiments, data store 130 comprises electronic storage media that electronically stores information. The electronic storage media of data store 130 may include one or both of system storage that is provided integrally (i.e., substantially non-removable) with system 100 and/or other storage that is connectable (wirelessly or via a wired connection) to system 100 via, for example, a port (e.g., a USB port, a firewire port, etc.), a drive (e.g., a disk drive, etc.), a network (e.g., the Internet, etc.). Data store 130 may be (in whole or in part) a separate component within system 100, or data store 130 may be provided (in whole or in part) integrally with one or more other components of system 100 (e.g., controller 114, external resources 146, etc.). In some embodiments, data store 130 may be located in a data center (e.g., a data center associated with a user), in a server that is part of external resources 146, in a computing device 134, 136, or 138, and/or in other locations. Data store 130 may include one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), or other electronically readable storage media. Data store 130 may store software algorithms, information determined by controller 114, information received via the graphical user interface displayed on computing devices 134, 136, and/or 138, information received from external resources 146, or other information accessed by system 100 to function as described herein.

Controller 114 is configured to coordinate the operation of the other components of identification engine 112 to provide the functionality described herein. Controller 114 may be formed by one or more processors, for example. Controlled components may include one or more of a family component 116, an recognition component 118, and/or other components. Controller 114 may be configured to direct the operation of components 116 and/or 118 by software; hardware; firmware; some combination of software, hardware, or firmware; or other mechanisms for configuring processing capabilities.

It should be appreciated that although components 116 and 118 are illustrated in FIG. 1 as being co-located, one or more of components 116 or 118 may be located remotely from the other components. The description of the functionality provided by the different components 116 and/or 118 described below is for illustrative purposes, and is not intended to be limiting, as any of the components 116 and/or 118 may provide more or less functionality than is described, which is not to imply that other descriptions are limiting. For example, one or more of components 116 and/or 118 may be eliminated, and some or all of its functionality may be provided by others of the components 116 and/or 118, again which is not to imply that other descriptions are limiting. As another example, controller 114 may be configured to control one or more additional components that may perform some or all of the functionality attributed below to one of the components 116 and/or 118. In some embodiments, identification engine 112 (e.g., controller 114 in addition to cache server 132, web server 128, and/or API server 126) is executed in a single computing device, or in a plurality of computing devices in a datacenter, e.g., in a service oriented or micro-services architecture.

Family component 116 is configured to generate a family set for a plurality of individuals. In some embodiments, the plurality of individuals comprises tens of individuals, hundreds of individuals, thousands of individuals, millions of individuals, or billions of individuals. The family set comprises mapped family relations designated between the plurality of individuals in the family set. In some embodiments, the mapped family relations comprise parent-child, sibling-sibling, grandparent-grandchild, uncle/aunt-nephew/niece, and/or corresponding inverses of these relationships. For example, a set of families with mapped relations may include father-son, father-daughter, brother-sister, grandmother-grandson, uncle-nephew, etc. As one possible example, the format of the family set can be in a table where each row specifies the relation between a first person and a second person.

Family component 116 is configured to obtain, assemble, receive, and/or otherwise generate an image gallery of families. The image gallery of families comprises one or more facial images of each of the plurality of individuals in the family set. The one or more facial images each comprise a unique identification that correlates to the mapped family relations designated between the plurality of individuals in the family set. Phrased another way, photo identifications are unique and correlate to the relationships data provided. The one or more facial images each comprise a unique identification that correlates to the mapped family relations designated between the plurality of individuals in the family set.

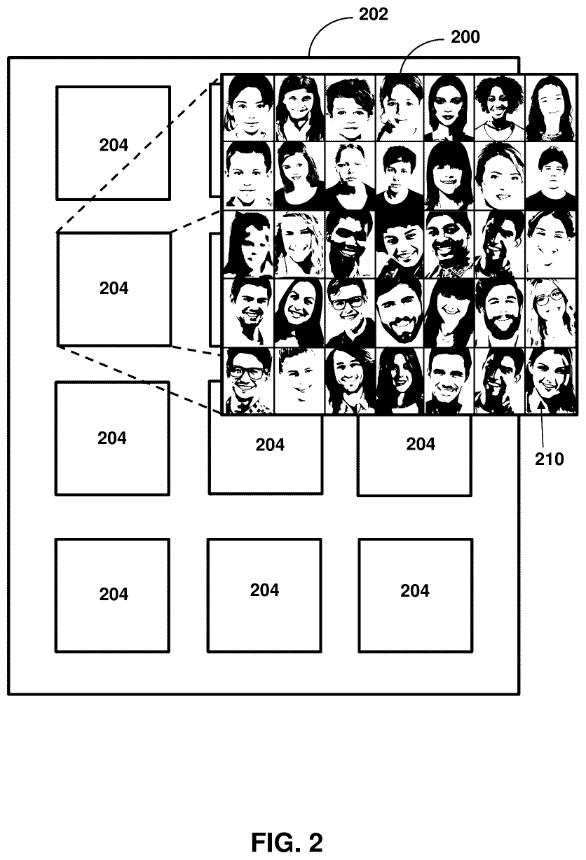

For example, FIG. 2 is a schematic illustration of images 200 of individuals from an image gallery 202 of families 204. As shown in FIG. 2, the image gallery 202 of families 204 comprises an image of a face of at least one person (see all of the people in broken out (e.g., as indicated by the dotted lines) family 204 shown in FIG. 2) in each family 204 and at least one face photo 210 for each person. In some embodiments, the images 200 of individuals and/or the image gallery 202 of families 204 may be automatically obtained by family component 116 (FIG. 1) from one or more electronically accessible databases and/or other sources. These databases may be provided within and/or outside of system 100 (e.g., by data store 130 and/or external resources 46 shown in FIG. 1). The information may be automatically obtained based on a user request, based on an image upload of an unknown subject, and/or based on other prompts.

In some embodiments, the images of individuals (e.g., the selected individuals and/or other individual with images in the image gallery 202 of families 204) may be and/or include two and/or three dimensional images, or sets of images of an individual's face and/or head. The images of individuals may be captured with still cameras, video cameras, may be generated by a model generation system, and/or may be generated by other methods. The images of individuals may include pre-labeled points of interest, reference points, linear and surface area topography, volumetric data, an indication of whether two or more of the images are from members of the same family, and/or other data.

In some embodiments, an image gallery comprises an image of the face of at least one person in each of several families. In some embodiments, the image gallery comprises an image of a face (e.g., a past or present image) of the unknown subject. However, typically there may be no image of the subject in the image gallery at all. In some embodiments, the images of at least 10, 100, 1000, 10000, 1000000, or 1000000000 or more individuals are stored in the image gallery. In some embodiments, the images of individuals and/or the image gallery may be automatically obtained by family component 116 (FIG. 1) from one or more electronically accessible databases and/or other sources. As described herein, these databases may be provided within and/or outside of system 100 (e.g., by data store 130 and/or external resources 146 shown in FIG. 1). The information may be automatically obtained based on a user request, based on an image upload of an unknown subject, and/or based on other prompts.

Returning to FIG. 1, family component 116 is configured such that a pre-processing operation runs on family members, splits them into different types of groups representing common phenotype representations in the facial photos of the group members. There may be similarity of facial characteristics or features (common phenotypes) between an unknown subject and individuals from the same family in the images in the image gallery. This similarity may be used for identification, as described herein. Similarity may comprise relatedness among individuals in a family. Characteristics may be similar between family members because family members share the same genes, and/or for other reasons.

Family component 116 is configured to process the image gallery of families based on the unique identifications to divide the plurality of individuals into different types of groups which represent common phenotypes in one or more facial images of group members. In some embodiments, a phenotype comprises a detectable characteristic in a facial image. Different phenotypes may comprise parts of faces, relative locations of parts of faces, distances between parts of faces, face size, face shape, indications of kinship, age, gender, race, eye color, hair color, skin color, presence of unique skin characteristics, bone structure, and/or other detectable characteristics. Note that these are just some representative examples of many more and/or different possibilities. Family component 116 is configured to correlate phenotypes that are related to kinship, rather than phenotypes that belong to the same person like in traditional facial recognition software where the software is looking for the exact unknown person.

In some embodiments, the processing performed by family component 116 comprises converting images in the image gallery to numerical data for analysis and/or other operations. The data may be representative of a given phenotype (or phenotypes), determinations made based on such data (e.g., face width, length, breadth, and/or other features, information related to three dimensional facial topography data (e.g., volumetric data), two dimensional image measurements, and/or other information. In some embodiments, the numerical data may include points of interest, reference points, linear and surface area topography, volumetric data, etc., from images that has been converted to numerical values for mathematical computation and analysis, and/or other numerical data. In some embodiments, the data comprises millions of individual data points.

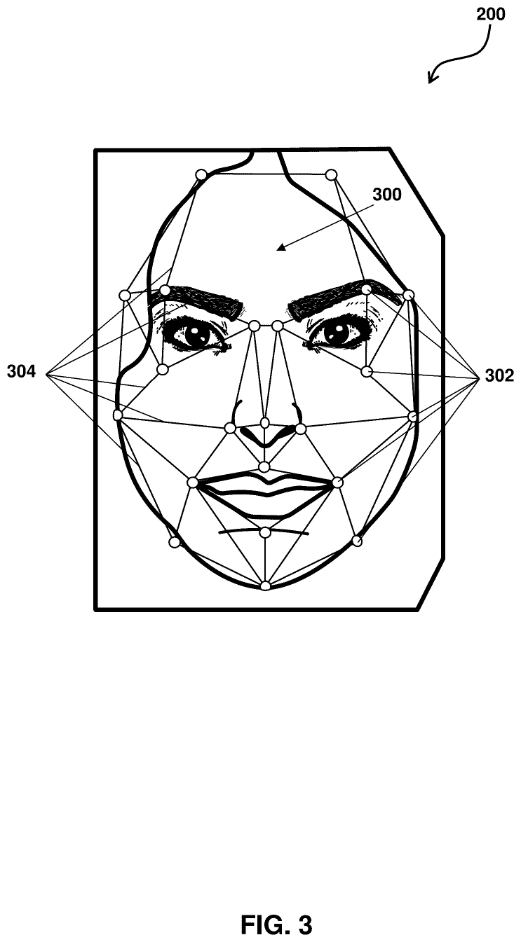

As a facial characteristic example, FIG. 3 illustrates an image 200 of a face 300 of an individual from an image gallery (e.g., 202 shown in FIG. 2) of families (e.g., 204 shown in FIG. 2). As described above, family component 116 (FIG. 1) is configured to divide the plurality of individuals into different types of groups which represent common phenotypes in one or more facial images of group members. In this example, various extracted facial features are indicated by the dots 302 and/or lines 304 shown on face 300. In some embodiments, family component 116 (FIG. 1) may be configured to determine locations of dots 302, distances between dots 302, shapes of lines 304, and/or other information. In this example, extracted facial features comprise a shape, size, location, relative location, distance between, etc., of parts (e.g., eyes, eye sockets, nose, cars, etc.) of face 300, topographical landmarks of face 300 (e.g. bridge of the nose, dimple of a chin, etc.), determinations made based on such data (e.g., face 300 appears female), full face width (see combination of lines 304 from check bone to cheekbone of face 300, and nose breadth (see dots 302 on either side of the nose of face 300 and the line 304 between those two dots). Again, these are just some representative examples of many more and/or different possibilities.

Returning to FIG. 1, family component 116 is configured such that weights are assigned and used to optimize familial signatures that represent different families in the image gallery of families. In some embodiments, the familial signatures are determined by extracting and aggregating common phenotypes associated with one or more facial images of individuals in a family. The aggregating may comprise averaging, as one example.

An aggregated representation of a family tends to have a general characteristic representation of the family, not just an individual's. Aggregating may comprise averaging, for example, and/or other aggregating. For example, images from various individuals may be labeled as and/or known to be family members. For some or all of the individuals in a given family, family component 116 may average and/or otherwise aggregate some or all of the characteristics such as the shape, size, location, relative location, distance between, etc., determinations made based on such data, width, length, breadth (these are just examples), age, gender, race, eye color, hair color, skin color, presence of unique skin characteristics, bone structure, and/or other detectable characteristics. Kinship can also be a base for the aggregated representation. For example, aggregating brothers, aggregating brothers and parents, etc. not necessarily based on the visual information, but instead based on the metadata provided. This may produce one aggregated measure for each characteristic, for each family, for example. In some embodiments, the extracted and/or otherwise estimated characteristics may be representative of a given individual. In some embodiments, the extracted characteristics for each individual in a family may be formed into a single aggregated representation of a family, whether as single number or multiple numbers, i.e. a vector. Such a vector is a collection of numbers representing various characteristics, for example. In some embodiments, the characteristic is not necessarily based on an observed or measurable feature of an image, for example, but instead may be a dimension a deep learning network determined based on statistical and/or other operations.

Weights for different family relationships (kinship), face parts, age, gender, race, or any other phenotype can be used to optimize the familial signature for a good representation of the family. In some embodiments, assigning and using weights to optimize familial signatures that represent different families in the image gallery of families comprises: assigning weights based on different types of family relations, including parent-child, sibling-sibling, grandparent-grandchild, uncle/aunt-nephew/niece, cousin-cousin, and/or corresponding inverses of these; determining separate face embeddings for each of the plurality of individuals; and determining weighted averages of facial embeddings for different sub-groups, the different sub-groups comprising grandparents, uncles, aunts, cousins, parents, siblings, brothers, and/or sisters. In some embodiments, assigning and using weights to optimize familial signatures that represent different families in the image gallery of families further comprises individually adjusting each weight as needed to enhance an accuracy of the familial signatures to represent the different families. Familial embeddings, individual embeddings, and/or other metadata such as described herein is saved in a database.

Recognition component 118 is configured to receive one or more facial images of a subject. In some embodiments, the subject is or was a missing child, a baby or child who has aged to an older child or adult, a subject who has experienced significant weight gain or loss, a subject who has aged enough to significantly change in physical appearance, a subject who has experienced significant hair loss, and/or a subject who has changed, or potentially changed, in appearance in some other way. The one or more facial images of the subject may comprise one or more current facial images taken after occurrence of potential appearance related changes to subject, for example. Images may be received by way of electronic upload and/or download, email, text, and/or other ways of electronically communicating an image.

Recognition component 118 is configured to detect one or more phenotypes of the subject based on the one or more facial images of the subject and/or other information. The one or more phenotypes of the subject are compared to the familial signatures to generate an ordered list of family probabilities from a family that is most correlated to, or most resembles, the subject to a family that is least correlated to, or least resembles, the subject. In some embodiments, comparing the one or more phenotypes of the subject to the familial signatures comprises determining an embedding representing the subject's face, with the embedding collectively representing one or more phenotypes associated with the subject, and comparing the embedding to each of the familial signatures. In some embodiments, the embedding is multidimensional, with different dimensions corresponding to different phenotypes of the subject. A corresponding family or families associated with a highest probability for the subject may be identified as potentially being the subject's family based on the comparing. Various distance functions on normalized vectors may be used for the comparing, for example.

With change-agnostic family matching, the photo of the subject is matched by system 100 with a closest family signature, and one or more relevant possible matching families are identified. The possible families are presented in descending order where the closest families are presented first. This ordered list of families is determined based on the comparing of the embedding to the familial signatures. In some embodiments, possible families in the ordered list may be displayed by a user interface, presented in descending order from the family that most resembles the subject to the family that least resembles the subject. In some embodiments, recognizing the subject is agnostic of whatever potential appearance related change may or may not have been undergone by the subject.

It should be noted that in some embodiments, identification engine 112 may be configured such that in the above mentioned operations of the controller 114, input from users and/or sources of information inside or outside system 100 may be processed by controller 114 through a variety of formats, including clicks, touches, uploads, downloads, etc., The illustrated components (e.g., controller 114, API server 126, web server 128, data store 130, and cache server 132) of identification engine 112 are depicted as discrete functional blocks, but embodiments are not limited to systems in which the functionality described herein is organized as illustrated by FIG. 1. The functionality provided by each of the components of identification engine 112 may be provided by software or hardware modules that are differently organized than is presently depicted, for example such software or hardware may be intermingled, broken up, distributed (e.g. within a data center or geographically), or otherwise differently organized. The functionality described herein may be provided by one or more processors of one or more computers executing code stored on a tangible, non-transitory, machine readable medium.

FIG. 4 is a diagram that illustrates an exemplary computer system 400 in accordance with embodiments of the present system. Various portions of systems and methods described herein may include or be executed on one or more computer systems the same as or similar to computer system 400. For example, identification engine 112, mobile user device 134, mobile user device 136, desktop user device 138, external resources 146 and/or other components of the system 100 (FIG. 1) may be and/or include one more computer systems the same as or similar to computer system 400. Further, processes, modules, processor components, and/or other components of system 100 described herein may be executed by one or more processing systems similar to and/or the same as that of computer system 400.

Computer system 400 may include one or more processors (e.g., processors 410a-410n) coupled to system memory 420, an input/output I/O device interface 430, and a network interface 440 via an input/output (I/O) interface 450. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computer system 400. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 420). Computer system 400 may be a uni-processor system including one processor (e.g., processor 410a), or a multi-processor system including any number of suitable processors (e.g., 410a-410n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computer system 400 may include a plurality of computing devices (e.g., distributed computer systems) to implement various processing functions.

I/O device interface 430 may provide an interface for connection of one or more I/O devices 460 to computer system 400. I/O devices may include devices that receive input (e.g., from a user) or output information (e.g., to a user). I/O devices 460 may include, for example, graphical user interface presented on displays (e.g., a touch screen or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 460 may be connected to computer system 400 through a wired or wireless connection. I/O devices 460 may be connected to computer system 400 from a remote location. I/O devices 460 located on a remote computer system, for example, may be connected to computer system 400 via a network and network interface 440.

Network interface 440 may include a network adapter that provides for connection of computer system 400 to a network. Network interface may 440 may facilitate data exchange between computer system 400 and other devices connected to the network. Network interface 440 may support wired or wireless communication. The network may include an electronic communication network, such as the Internet, a local area network (LAN), a wide area network (WAN), a cellular communications network, or the like.

System memory 420 may be configured to store program instructions 470 or data 480. Software such as program instructions 470 may be executable by a processor (e.g., one or more of processors 410a-410n) to implement one or more embodiments of the present techniques. Instructions 470 may include modules and/or components (e.g., components 16 and 18 shown in FIG. 1) of computer program instructions for implementing one or more techniques described herein with regard to various processing modules and/or components. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 420 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 420 may include a non-transitory computer readable storage medium that may have program instructions stored thereon that are executable by a computer processor (e.g., one or more of processors 410a-410n) to cause the subject matter and the functional operations described herein. A memory (e.g., system memory 420) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 450 may be configured to coordinate I/O traffic between processors 410a-410n, system memory 420, network interface 440, I/O devices 460, and/or other peripheral devices. I/O interface 450 may perform protocol, timing, or other data transformations to convert data signals from one component (e.g., system memory 420) into a format suitable for use by another component (e.g., processors 410a-410n). I/O interface 450 may include support for devices attached through various types of peripheral buses, such as a variant of the Peripheral Component Interconnect (PCI) bus standard or the Universal Serial Bus (USB or USB-C) standard.

Embodiments of the techniques described herein may be implemented using a single instance of computer system 400 or multiple computer systems 400 configured to host different portions or instances of embodiments. Multiple computer systems 400 may provide for parallel or sequential processing/execution of one or more portions of the techniques described herein.

Those skilled in the art will appreciate that computer system 400 is merely illustrative and is not intended to limit the scope of the techniques described herein. Computer system 400 may include any combination of devices or software that may perform or otherwise provide for the performance of the techniques described herein. For example, computer system 400 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a television or device connected to a television (e.g., Apple TV™), or a Global Positioning System (GPS), or the like. Computer system 400 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

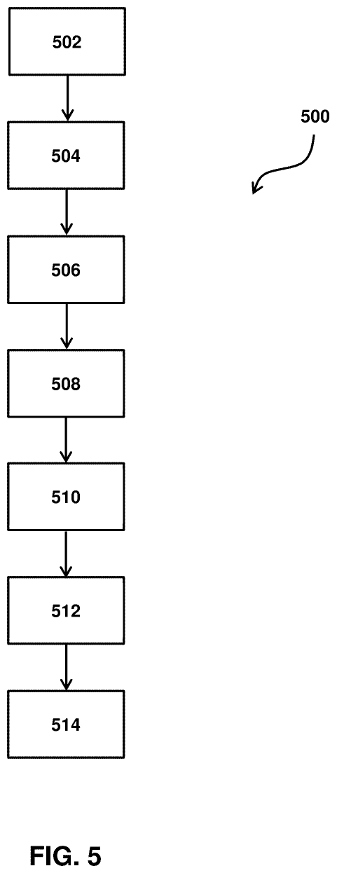

FIG. 5 is a flowchart of a method 500 for identifying subjects based on correlated family relation (e.g., kinship) characteristics. Method 500 is a method for facilitating recognition of a subject by identifying the subject's family in an image gallery of families, whether or not the subject's appearance has changed, by exploiting a genetic similarity of facial features between family members. Method 500 may be performed with some embodiments of system 100 (FIG. 1), computer system 400 (FIG. 4), and/or other components discussed above.

Method 500 includes generating (operation 502) a family set for a plurality of individuals. The family set comprises mapped family relations designated between the plurality of individuals in the family set. Method 500 includes generating (operation 504) the image gallery of families. The image gallery of families comprises one or more facial images of each of the plurality of individuals in the family set. The one or more facial images each comprise a unique identification that correlates to the mapped family relations designated between the plurality of individuals in the family set. Method 500 includes processing (operation 506) the image gallery of families based on the unique identifications to divide the plurality of individuals into different types of groups which represent common phenotypes in one or more facial images of group members. Weights are assigned and used to optimize familial signatures that represent different families in the image gallery of families. Method 500 includes receiving (operation 508) one or more facial images of the subject. The one or more facial images of the subject comprise one or more current facial images taken after occurrence of potential appearance related changes to subject. Method 500 includes detecting (operation 510) one or more phenotypes of the subject based on the one or more facial images of the subject; and comparing (operation 512) the one or more phenotypes of the subject to the familial signatures to generate an ordered list of family probabilities from a family that most resembles the subject to a family that least resembles the subject. Method 500 includes identifying (operation 514) a corresponding family associated with a highest probability for the subject as the subject's family based on the comparing.

Method 500 may include additional operations that are not described, and/or may not include one or more of the operations described. The operations of method 500 may be performed in any order that facilitates correct (or high confidence) identifications, as described herein.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

What is claimed is:

1. A non-transitory computer readable medium having instructions thereon, the instructions when executed by a computer, causing the computer to facilitate recognition of a subject by identifying the subject's family in an image gallery of families, whether or not the subject's appearance has changed, by exploiting a genetic similarity of facial features between family members; the instructions causing operations comprising:
generating a family set for a plurality of individuals, the family set comprising mapped family relations designated between the plurality of individuals in the family set;
generating the image gallery of families, the image gallery of families comprising one or more facial images of each of the plurality of individuals in the family set, the one or more facial images each comprising a unique identification that correlates to the mapped family relations designated between the plurality of individuals in the family set;
processing the image gallery of families based on the unique identifications to divide the plurality of individuals into different types of groups which represent common phenotypes in one or more facial images of group members, wherein weights are assigned and used to optimize familial signatures that represent different families in the image gallery of families;
receiving one or more facial images of the subject, the one or more facial images of the subject comprising one or more current facial images taken after occurrence of potential appearance related changes to subject;
detecting one or more phenotypes of the subject based on the one or more facial images of the subject; and
comparing the one or more phenotypes of the subject to the familial signatures to generate an ordered list of family probabilities from a family that most resembles the subject to a family that least resembles the subject.

2. The medium of claim 1, wherein the subject is or was a missing child, a baby or child who has aged to an older child or adult, a subject who has experienced significant weight gain or loss, a subject who has aged enough to significantly change in physical appearance, and/or a subject who has experienced significant hair loss.

3. The medium of claim 1, wherein the plurality of individuals comprises hundreds of individuals, thousands of individuals, millions of individuals, or billions of individuals.

4. The medium of claim 1, wherein the mapped family relations comprise parent-child, sibling-sibling, grandparent-grandchild, uncle/aunt-nephew/niece, and corresponding inverses of these relationships.

5. The medium of claim 1, wherein a phenotype comprises a detectable characteristic in a facial image.

6. The medium of claim 5, wherein the different phenotypes comprise parts of faces, indications of kinship, age, gender, race, eye color, hair color, skin color, presence of unique skin characteristics, and/or bone structure.

7. The medium of claim 6, wherein assigning and using weights to optimize familial signatures that represent different families in the image gallery of families comprises:
assigning weights based on different types of family relations, including parent-child, sibling-sibling, grandparent-grandchild, uncle/aunt-nephew/niece, cousin-cousin, and/or corresponding inverses of these;
determining separate face embeddings for each of the plurality of individuals; and
determining weighted averages of facial embeddings for different sub-groups, the different sub-groups comprising grandparents, uncles, aunts, cousins, parents, siblings, brothers, and/or sisters.

8. The medium of claim 7, wherein assigning and using weights to optimize familial signatures that represent different families in the image gallery of families further comprises individually adjusting each weight as needed to enhance an accuracy of the familial signatures to represent the different families.

9. The medium of claim 1, the operations further comprising saving familial embeddings, individual embeddings, and corresponding metadata in a database.

10. The medium of claim 1, wherein recognizing the subject is agnostic of whatever potential appearance related change may or may not have been undergone by the subject.

11. The medium of claim 1, wherein the familial signatures are determined by extracting and aggregating common phenotypes associated with one or more facial images of individuals in a family.

12. The medium of claim 11, wherein the aggregating comprises averaging.

13. The medium of claim 1, the operations further comprising causing display, in a user interface, of possible families in the ordered list, presented in descending order from the family that most resembles the subject to the family that least resembles the subject.

14. The medium of claim 1, wherein comparing the one or more phenotypes of the subject to the familial signatures comprises determining an embedding representing the subject's face, the embedding collectively representing one or more phenotypes associated with the subject, and comparing the embedding to each of the familial signatures, and wherein the ordered list of family probabilities is determined based on the comparing of the embedding to the familial signatures.

15. The medium of claim 14, wherein the embedding is multidimensional, with different dimensions corresponding to different phenotypes of the subject.

16. A method for facilitating recognition of a subject by identifying the subject's family in an image gallery of families, whether or not the subject's appearance has changed, by exploiting a genetic similarity of facial features between family members; the method comprising:
generating a family set for a plurality of individuals, the family set comprising mapped family relations designated between the plurality of individuals in the family set;
generating the image gallery of families, the image gallery of families comprising one or more facial images of each of the plurality of individuals in the family set, the one or more facial images each comprising a unique identification that correlates to the mapped family relations designated between the plurality of individuals in the family set;
processing the image gallery of families based on the unique identifications to divide the plurality of individuals into different types of groups which represent common phenotypes in one or more facial images of group members, wherein weights are assigned and used to optimize familial signatures that represent different families in the image gallery of families;
receiving one or more facial images of the subject, the one or more facial images of the subject comprising one or more current facial images taken after occurrence of potential appearance related changes to subject;
detecting one or more phenotypes of the subject based on the one or more facial images of the subject; and
comparing the one or more phenotypes of the subject to the familial signatures to generate an ordered list of family probabilities from a family that most resembles the subject to a family that least resembles the subject.

17. The method of claim 16, wherein the subject is or was a missing child, a baby or child who has aged to an older child or adult, a subject who has experienced significant weight gain or loss, a subject who has aged enough to significantly change in physical appearance, and/or a subject who has experienced significant hair loss.

18. The method of claim 16, wherein the plurality of individuals comprises hundreds of individuals, thousands of individuals, millions of individuals, or billions of individuals.

19. The method of claim 16, wherein the mapped family relations comprise parent-child, sibling-sibling, grandparent-grandchild, uncle/aunt-nephew/niece, and corresponding inverses of these relationships.

20. The method of claim 16, wherein a phenotype comprises a detectable characteristic in a facial image.

21. The method of claim 20, wherein the different phenotypes comprise parts of faces, indications of kinship, age, gender, race, eye color, hair color, skin color, presence of unique skin characteristics, and/or bone structure.

22. The method of claim 21, wherein assigning and using weights to optimize familial signatures that represent different families in the image gallery of families comprises:
assigning weights based on different types of family relations, including parent-child, sibling-sibling, grandparent-grandchild, uncle/aunt-nephew/niece, cousin-cousin, and/or corresponding inverses of these;
determining separate face embeddings for each of the plurality of individuals; and
determining weighted averages of facial embeddings for different sub-groups, the different sub-groups comprising grandparents, uncles, aunts, cousins, parents, siblings, brothers, and/or sisters.

23. The method of claim 22, wherein assigning and using weights to optimize familial signatures that represent different families in the image gallery of families further comprises individually adjusting each weight as needed to enhance an accuracy of the familial signatures to represent the different families.

24. The method of claim 16, further comprising saving familial embeddings, individual embeddings, and corresponding metadata in a database.

25. The method of claim 16, wherein recognizing the subject is agnostic of whatever potential appearance related change may or may not have been undergone by the subject.

26. The method of claim 25, wherein the familial signatures are determined by extracting and aggregating common phenotypes associated with one or more facial images of individuals in a family.

27. The method of claim 26, wherein the aggregating comprises averaging.

28. The method of claim 16, further comprising causing display, in a user interface, of possible families in the ordered list, presented in descending order from the family that most resembles the subject to the family that least resembles the subject.

29. The method of claim 16, wherein comparing the one or more phenotypes of the subject to the familial signatures comprises determining an embedding representing the subject's face, the embedding collectively representing one or more phenotypes associated with the subject, and comparing the embedding to each of the familial signatures, and wherein the ordered list of family probabilities is determined based on the comparing of the embedding to the familial signatures.

30. The method of claim 26, wherein the embedding is multidimensional, with different dimensions corresponding to different phenotypes of the subject.

31. A non-transitory computer readable medium having instructions thereon, the instructions when executed by a computer, causing the computer to facilitate recognition of a subject by identifying the subject's family in an image gallery of families, whether or not the subject's appearance has changed, by exploiting a genetic similarity of facial features between family members; the instructions causing operations comprising:
receiving one or more facial images of the subject, the one or more facial images of the subject comprising one or more current facial images taken after occurrence of potential appearance related changes to subject;
detecting one or more phenotypes of the subject based on the one or more facial images of the subject; and
comparing the one or more phenotypes of the subject to familial signatures to generate an ordered list of family probabilities from a family that most resembles the subject to a family that least resembles the subject;
wherein:
a family set comprises mapped family relations designated between a plurality of individuals in the family set;
the image gallery of families comprises one or more facial images of each of the plurality of individuals in the family set, the one or more facial images each comprising a unique identification that correlates to the mapped family relations designated between the plurality of individuals in the family set; and
the image gallery of families has been processed based on the unique identifications to divide the plurality of individuals into different types of groups which represent common phenotypes in one or more facial images of group members, wherein weights have been assigned and used to optimize familial signatures that represent different families in the image gallery of families.

32. The medium of claim 31, wherein the subject is or was a missing child, a baby or child who has aged to an older child or adult, a subject who has experienced significant weight gain or loss, a subject who has aged enough to significantly change in physical appearance, and/or a subject who has experienced significant hair loss.

33. The medium of claim 31, wherein the plurality of individuals comprises hundreds of individuals, thousands of individuals, millions of individuals, or billions of individuals.

34. The medium of claim 31, wherein the mapped family relations comprise parent-child, sibling-sibling, grandparent-grandchild, uncle/aunt-nephew/niece, and corresponding inverses of these relationships.

35. The medium of claim 31, wherein a phenotype comprises a detectable characteristic in a facial image.

36. The medium of claim 35, wherein the different phenotypes comprise parts of faces, indications of kinship, age, gender, race, eye color, hair color, skin color, presence of unique skin characteristics, and/or bone structure.

37. The medium of claim 36, wherein assigning and using weights to optimize familial signatures that represent different families in the image gallery of families comprises:
assigning weights based on different types of family relations, including parent-child, sibling-sibling, grandparent-grandchild, uncle/aunt-nephew/niece, cousin-cousin, and/or corresponding inverses of these;
determining separate face embeddings for each of the plurality of individuals; and
determining weighted averages of facial embeddings for different sub-groups, the different sub-groups comprising grandparents, uncles, aunts, cousins, parents, siblings, brothers, and/or sisters.

38. The medium of claim 37, wherein assigning and using weights to optimize familial signatures that represent different families in the image gallery of families further comprises individually adjusting each weight as needed to enhance an accuracy of the familial signatures to represent the different families.

39. The medium of claim 31, the operations further comprising saving familial embeddings, individual embeddings, and corresponding metadata in a database.

40. The medium of claim 31, wherein recognizing the subject is agnostic of whatever potential appearance related change may or may not have been undergone by the subject.

41. The medium of claim 31, wherein the familial signatures are determined by extracting and aggregating common phenotypes associated with one or more facial images of individuals in a family.

42. The medium of claim 41, wherein the aggregating comprises averaging.

43. The medium of claim 31, the operations further comprising causing display, in a user interface, of possible families in the ordered list, presented in descending order from the family that most resembles the subject to the family that least resembles the subject.

44. The medium of claim 31, wherein comparing the one or more phenotypes of the subject to the familial signatures comprises determining an embedding representing the subject's face, the embedding collectively representing one or more phenotypes associated with the subject, and comparing the embedding to each of the familial signatures, and wherein the ordered list of family probabilities is determined based on the comparing of the embedding to the familial signatures.

45. The medium of claim 44, wherein the embedding is multidimensional, with different dimensions corresponding to different phenotypes of the subject.
